(19) United States
(12) Patent Application Publication
(10) Pub. No.: US 2008/0264851 A1
(43) Pub. Date: Oct. 30, 2008

(54) Dual compartment, single cabinet water softener

(75) Inventor: Keith A. Emerson, Groveport, OH (US)

Correspondence Address: MUELLER AND SMITH, LPA;MUELLER-SMITH BUILDING, 7700 RIVERS EDGE DRIVE, COLUMBUS, OH, 43235, US

(73) Assignee: Wm. R. Hague, Inc., Groveport, OH (US)

(21) Appl. No.: 11/789,574

(22) Filed: Apr. 25, 2007

(51) Int. Cl. B01D 24/46

(52) U.S. Cl. 210/269; 210/264; 210/281; 210/232

(57) ABSTRACT

A water softener is composed of a cabinet of a resin bed, a brine tank, and a brine valve. The improved water softener has an outer housing having sides, a bottom, and an open top. A wall is disposed within the housing forming a brine chamber and a resin bed chamber for housing ion-exchange resin beads. Cross-contamination of the resin beads by the brine is prevented.

### CROSS-REFERENCE TO RELATED APPLICATIONS

None

### STATEMENT REGARDING FEDERALLY SPONSORED RESEARCH

Not applicable.

### BACKGROUND

The present disclosure relates to water treatment systems, sometimes commonly known as “water softening systems” or simply “water softeners”, and more particularly to a unique single cabinet that uniquely houses both the brine tank and the resin tank.

Resin-type ion exchange devices have many uses, such as the softening of water. As the water to be processed is passed through the resin-filled tank, ions in the fluid to be processed, e.g., calcium, are exchanged with ions found in the resin, e.g., sodium, thereby removing objectionable ions found in the water. During this ion exchange process, the ability of the resin to exchange ions gradually is reduced. That is, the resin bed becomes exhausted and, thereafter, water will flow therethrough in unprocessed form.

The capacity of the ion exchange resin bed can be determined from the volume of resin used and the particular type of resin. The concentration of contaminant(s) in the water to be processed can be determined, at least on an average basis. Thus, the volume of water that can be processed by a particular water treatment unit is known. Once that capacity of water has been treated, the bed must be regenerated.

Regeneration of the ion exchange resins typically involves chemically replacing the objectionable ions from the resin with less objectionable ions, e.g., replacing calcium with sodium ions. This regeneration process requires the suspension of the treatment process; thus, necessitating the water to bypass the ion exchange resin tank. At the same time as the ion exchange resin is regenerated, the bed can be backwashed in order to remove trapped particulate matter, the resin tank can be rinsed to remove objectionable soluble materials, an application of sterilization agent to prevent bacterial growth can be accomplished, etc. All of these operations are known in the art.

Water flow between the resin bed and the regenerating or salt bed is controlled by a brine valve, which as its name implies, must have the ability to divert brine from the salt bed into and through the resin bed to reactivate or regenerate it. Typically, water softeners are composed of two tanks: a brine tank and a resin bed or bead tank. Appropriate piping along with the brine valve accomplishes the water softening operations, as described above. Occasionally, however, a single cabinet houses the brine tank within the same compartment with appropriate piping with the brine valve provided in conventional fashion. This design, however, does not meet, for example, current European regulations designed to prevent cross-contamination between the resin bed and the brine tank.

It is an improved single cabinet water softener design meeting such regulations that the present disclosure is directed.

### BRIEF SUMMARY

A water softener is composed of a cabinet of a resin bed, a brine tank, and a brine valve. The improved water softener has an outer housing having sides, a bottom, and an open top. A wall is disposed within the housing forming a brine chamber and a resin tank.

Advantages include complete separation of the brine from the resin beads for preventing cross-contamination. Another advantage includes the shippability of the resulting cabinet. These and other advantages will be apparent to the skilled artisan based on the disclosure set forth herein.

### BRIEF DESCRIPTION OF THE DRAWINGS

For a fuller understanding of the nature and advantages of the present disclosure, reference should be had to the following detailed description taken in connection with the accompanying drawings, in which:

FIG. 1 is a perspective view of the cabinet with the top removed;

FIG. 2 is a front view of the cabinet;

FIG. 3 is a side view of the cabinet;

FIG. 4 is a view of the cabinet; and

FIG. 5 is a section view taken along line 4-4 of FIG. 4.

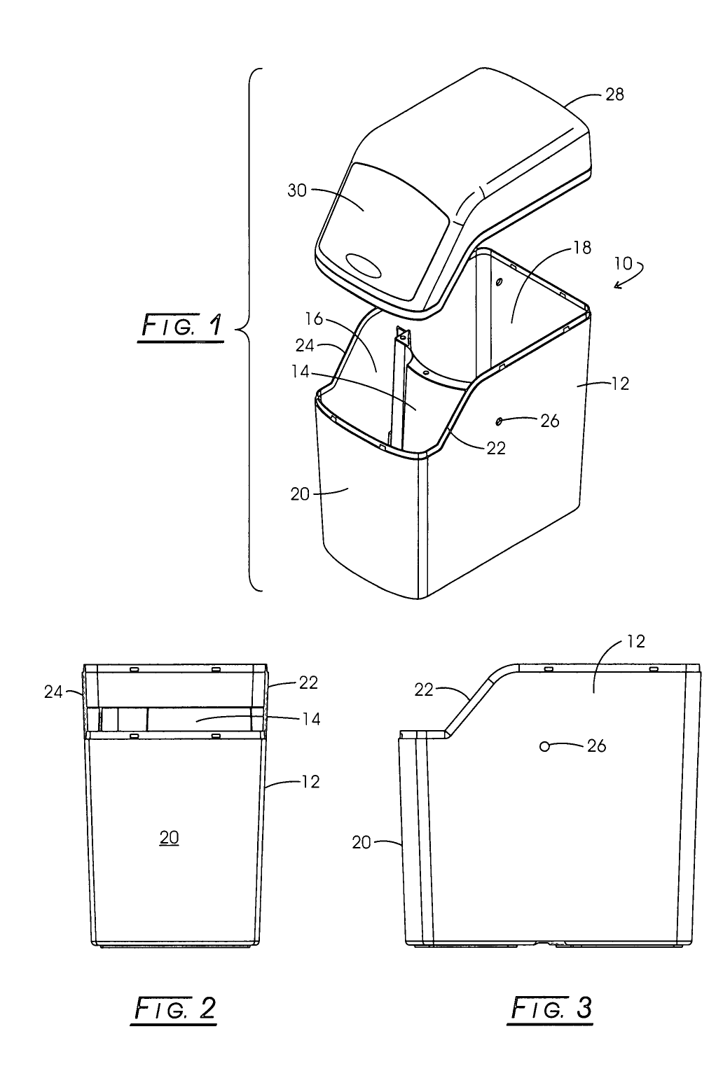

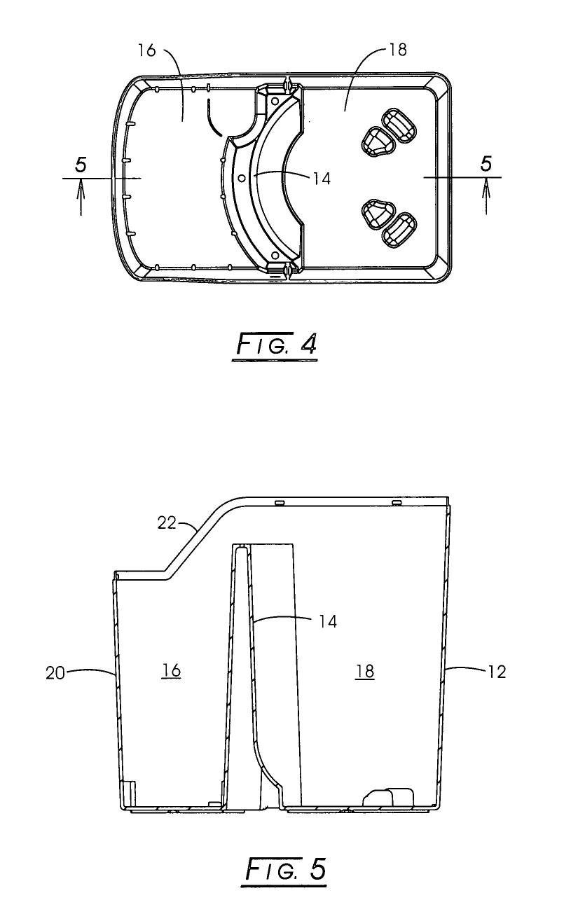

The drawings will be described in further detail below.

### DETAILED DESCRIPTION

Of importance in the present water softener, 10, is a cabinet, 12, design that isolates the brine from the resin beads in a single cabinet water softener. Cabinet 12 is illustrated to be rectangular in design, but any geometric shape can be used, such as, for example, to facilitate manufacturing, reduce costs, assist in shipping ease, and the like. Piping, valves, overflow tubes, controllers, and like conventional water softener apparatus has been omitted from the drawings and will only be briefly referred to, as such equipment is conventional in design. Also, while the cabinet components are manufactured from polymeric materials (plastics) conveniently molded into shape, other materials of construction can be used at the sacrifice of manufacturing cost and expense, shipping costs, and the like.

Disposed within cabinet 12 is a wall, 14, that is shown slightly convex in shape for strength considerations. It also is double-wall construction (see FIGS. 4 and 5) for strength of cabinet 12 and as extra support during shipping. Wall 14 can be molded into cabinet 12 or can be inserted after formation of cabinet 12 by appropriate welding or other attachment modality ensuring a water-tight seal against the inside walls of cabinet 12.

Wall 14 forms a forward brine chamber, 16, for housing salt and a rearward resin bead chamber, 18, for housing resin (ion-exchange) beads. These two chambers can be placed side-by-side, diagonally, or any other convenient configuration. Placing the brine tank forwardly and lowering the front panel, 20, enables the user to more easily re-fill brine chamber 16 with replacement salt from time to time as the salt therein is consumed. Thus, sidewalls, 22 and 24, forming brine chamber 16 slope downwardly to front wall 20. Again, this is for convenience of the user and not an operability constraint placed on cabinet 10.

Overflow aperture, 26, in one of the sidewalls forming brine chamber 16 can be connected to an overflow tube in conventional fashion should the amount of water in brine chamber 16 exceed the volume thereof. Again, this is conventional in water softener cabinet design. Also, a brine pickup tube assembly sets down inside of brine chamber 16 and is connected to the valve assembly similarly set down inside of resin bead chamber 18, wherein brine made in brine chamber 16 flows through the pickup tube assembly through the valve assembly and washes the resin beads for their regeneration. Both the brine pickup tube assembly and the valve assembly are conventional in all resin-type ion exchange water softeners. Conventional also is the operation of the disclosed water softener in terms of timing of regeneration, response to unanticipated heavy water usage, and the like. See, for example, U.S. Pat. Nos. 5,089,140, 5,378,370, 5,116,491, 5,157,979, and 5,300,230, for a fuller discussion there.

Conveniently, also, a lid, 28, overfits the open top seals cabinet 12 from the outside. Lid 28 has a door, 30, located over brine chamber 16 for its refilling with salt (NaCl) by the user in conventional fashion.

While the water softener cabinet has been described with reference to various embodiments, those skilled in the art will understand that various changes may be made and equivalents may be substituted for elements thereof without departing from the scope and essence of the disclosure. In addition, many modifications may be made to adapt a particular situation without departing from the essential scope thereof. Therefore, it is intended that the water softener cabinet not be limited to the particular embodiments disclosed, but that the water softener cabinet will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. In a water softener of a resin bed, a brine tank, and a brine valve, the improvement which comprises:
(a) an outer housing having sides, a bottom, and an open top; and
(b) a wall disposed within said housing forming a brine chamber for housing brine solution and a resin bed chamber for housing resin beads.

2. The improved water softener of claim 1, wherein the open top is fitted with a lid.

3. The improved water softener of claim 1, wherein said wall comprises a pair of spaced-apart wall sections connected at their tops.
